(19) United States
(12) Patent Application Publication
(10) Pub. No.: US 2014/0153488 A1
(43) Pub. Date: Jun. 5, 2014

(54) INTERFERENCE CANCELLATION

(71) Applicant: BROADCOM CORPORATION, Irvine, CA (US)

(72) Inventors: Tommi Tapani KOIVISTO, Espoo (FI); Mihai Horatiu ENESCU, Espoo (FI); Timo Eric ROMAN, Espoo (FI); Karl Marko Juhani LAMPINEN, Oulu (FI)

(73) Assignee: BROADCOM CORPORATION, Irvine, CA (US)

(21) Appl. No.: 14/095,268

(22) Filed: Dec. 3, 2013

(30) Foreign Application Priority Data
Dec. 3, 2012 (GB) 1221718.8

(51) Int. Cl. H04B 1/10

(52) U.S. Cl. CPC H04B 1/10
USPC 370/328

(57) ABSTRACT

A network node includes, into a field of downlink control information that provides a user equipment with information for reception and decoding of data transmitted from the network node to the user equipment in a mobile communication network, an indication of receiver information. The receiver information is applicable for interference suppression/cancellation by a receiving operation of the user equipment, capable of performing interference suppression/cancellation using the receiver information. The user equipment detects the receiver information from the downlink control information, and can select a receiving operation using the receiver information.

### CROSS REFERENCE TO RELATED APPLICATION

This application claims the benefit under 35 U.S.C. §119(a) and 37 CFR §1.55 to UK Patent Application No. 1221718.8, filed on Dec. 3, 2012, the entire content of which is incorporated herein by reference.

### FIELD OF INVENTION

The present invention relates to interference cancellation or suppression.

### BACKGROUND INFORMATION

The following meanings for the abbreviations used in this specification apply:
BPSK binary phase shift keying
CoMP collaborative multipoint transmission
CQI channel quality indication
CRS common reference symbols
CSI channel state information
CSI-RS channel state information reference signal
CVM complex valued modulation
DL downlink
DM-RS demodulation reference signal
HARQ hybrid automatic repeat request
HS-SCCH high speed-shared control channel
HSPA high speed packet access
IC interference cancellation
IRC interference rejection combining
LPN low power nodes
LMMSE linear minimum mean square error
LTE long term evolution
MCS modulation and coding scheme
MIMO multiple-input and multiple-output
M-QAM M-quadrature amplitude modulation
MTC machine type communication
MU-MIMO multi-user MIMO
OLLA outer-loop link adaptation
PAM pulse amplitude modulation
PCI physical cell identifier
PDCCH physical downlink control channel
PDSCH physical downlink shared channel
PIC parallel interference cancellation
PMI precoding matrix indication
PRB physical resource block
PRG precoding resource group
RRC radio resource control
RRH remote radio head
RSRP reference signal received power
RVM real valued modulation
Rx receive(r)
SAIC single antenna interference cancellation
SINR signal-to-interference and noise ratio
SNR signal-to-noise ratio
TP transmission point
TR technical report
UE user equipment
W work item
WID work item description

Increased network density, which is one of the characteristics of network deployment scenarios in LTE Release 12 and beyond, leads to increased interference conditions. At the transmitter side, CoMP transmissions are envisioned to improve the cell edge performance by turning interference into useful signals. Interference may also be tackled at the receiver end, for example Release 11 specifies minimum performance requirements for receivers based on linear minimum mean square error (LMMSE) interference rejection combining (IRC).

Another type of advanced receiver enabling interference cancellation is based on interference cancellation (IC) in which the receiver detects (and eventually decodes) the interfering signal and cancels it out using the detected symbols/bits and corresponding channel estimates.

### SUMMARY

In accordance with a first aspect of the present invention, there is provided a method of enabling a receiving operation, the method including:

processing downlink control information that provides a user equipment with information for reception and decoding of data transmitted from a network node to the user equipment in a mobile communication network;

detecting, from the downlink control information, receiver information applicable for interference suppression and/or cancellation;

selecting a receiving operation capable of performing interference suppression and/or cancellation using the receiver information; and

processing the data transmitted from the network node by utilizing the selected receiving operation.

In accordance with a second aspect of the present invention, there is provided a method of enabling a receiving operation, the method including:

generating downlink control information that provides a user equipment with information for reception and decoding of data transmitted from a network node to the user equipment in a mobile communication network;

including, into a field of the downlink control information, an indication of receiver information applicable for interference suppression and/or cancellation by a receiving operation of the user equipment, capable of performing interference suppression and/or cancellation using the receiver information; and

providing the downlink control information including the indication to the user equipment.

In accordance with a third aspect of the present invention, there is provided a computer program product including a computer program for a processing device, the computer program including software code portions for performing the steps of the first or second aspects of the present invention when the program is run on the processing device.

In accordance with a fourth aspect of the present invention, there is provided apparatus for enabling a receiving operation in a user equipment, the apparatus including a processing system configured to cause the apparatus at least to:

process downlink control information that provides the user equipment with information for reception and decoding of data transmitted from a network node to the user equipment in a mobile communication network;

detect, from the downlink control information, receiver information applicable for interference suppression and/or cancellation;

select a receiving operation capable of performing interference suppression and/or cancellation using the receiver information; and

process the data transmitted from the network node by utilizing the selected receiving operation.

In accordance with a fifth aspect of the present invention, there is provided apparatus for enabling a receiving operation in a network node, the apparatus including a processing system configured to cause the apparatus at least to:

generate downlink control information that provides a user equipment with information for reception and decoding of data transmitted from the network node to the user equipment in a mobile communication network;

include, into a field of the downlink control information, an indication of receiver information applicable for interference suppression and/or cancellation by a receiving operation of the user equipment, capable of performing interference suppression and/or cancellation using the receiver information; and

provide the downlink control information including the indication to the user equipment.

The invention involves supporting interference canceling receivers, for example, in LTE and HSPA systems.

The present invention deals with signaling support for enabling operation of advanced receivers based on either real-valued modulation or enhanced IC, as detailed in the description of the embodiments.

For example, some embodiments of the invention enable utilization of:

widely linear LMMSE-IRC receivers taking advantage of real valued modulations: according to an embodiment, dynamic signaling of complex- and real-valued modulation is enabled without increasing DCI overhead.

enhanced IC receivers: according to an embodiment, cancellation of one dominant interferer and in particular informing a UE about detection parameters (resource allocation, MCS) of the dominant interferer is enabled. This is also done without increasing DCI overhead.

Both types of receivers lead to efficient interference cancellation and/or suppression in low SINR conditions. Additionally, the present invention may be applied to both CRS and DM-RS based transmission modes.

Further features and advantages of the invention will become apparent from the following description of preferred embodiments of the invention, given by way of example only, which is made with reference to the accompanying drawings.

### BRIEF DESCRIPTION OF THE DRAWINGS

FIGS. 1A and 1B show flowcharts illustrating processes of enabling a receiving operation according to an embodiment of the invention;

FIG. 2 shows a schematic block diagram illustrating a configuration of control units in which embodiments of the invention are implementable.

### DETAILED DESCRIPTION

Advanced receivers provide a way to suppress/mitigate interference at the receiver end. An improvement to LMMSE-IRC receivers is based on real valued modulations which, by exploiting the I/Q, domain lead to increased degrees of freedom in terms of interference cancellation. Current LTE specifications support complex constellations (M-QAM). Hence, a UE equipped with 2 Rx antennas can efficiently mitigate inter-cell interference from one rank 1 complex-valued interferer signal, provided the desired transmission is rank 1 complex-valued as well. A real valued modulation transmission enables increasing the degrees of freedom in the receiver as the intended transmission occupies one dimension out of four available (2 I/Q branches×2 Rx antennas). Such techniques can be even more appealing in MTC devices where only one Rx chain is envisioned to be utilized in order to decrease UE costs. With 1 Rx antenna, real valued modulation can enable rank 1 desired signal reception and rank 1 inter-cell interference cancellation. The receivers taking advantage of non-circular interference (arising from real-valued modulations) are known in the academic literature as widely linear receivers.

The prerequisite for efficient interference cancellation using the I/Q domain is that both the desired signal and the interferer are real valued (or more generally use modulations that are statistically non-circular). With the introduction of real valued modulations, in addition to the existing complex modulations, it is clear that downlink signaling is needed in order to enable correct utilization of the modulation at the UE side. This may be accomplished without adding much downlink signaling overhead.

An aspect of this invention is directed to signaling of modulation information to the UE when a mixture of complex- and real-valued modulations is utilized in the system.

Similarly, enhanced IC-based receivers, e.g. SIC receivers, are based on signaling of information about the interfering signal to enable detection of the interfering symbols and possibly also decoding of the actual bits in order to enable cancellation of the interference. The information may include, depending on the exact type of enhanced IC-receiver, for instance the resource allocation, modulation, or even full MCS information of the interfering stream including also for instance the HARQ redundancy version. Additionally, when DM-RS are used for demodulation, the UE may need to know the antenna ports for both the wanted and the interfering signals as well as the corresponding scrambling ID for DM-RS sequence generation. When CRS are used for demodulation, the UE may need to know the (wideband) PMI information for both the wanted and the interfering signals.

It is to be noted that reference is made herein to interference cancellation receivers that detect and possibly decode interfering codeword(s) in addition to wanted codeword(s). Such interference cancellation receivers include for example successive interference cancellation (SIC) receivers (also referred to as serial interference cancellation receivers), but no limitation to just SIC receivers should be implied herein. There are also possible variants of SIC: linear minimum square error (LMMSE) SIC involving a linear detection stage followed by a non-linear SIC stage, maximum-likelihood (ML) SIC involving a non-linear ML detection stage followed by a non-linear SIC. One may also consider ML receivers without an SIC stage that perform joint detection of both wanted codeword(s) and interfering codeword(s). One may also consider even more complicated receiver structures such as iterative turbo SIC receivers where post channel decoding soft information bits are used as a-priori information for detection of both wanted codeword(s) and interfering codeword(s). Interference cancellation may also be conducted in parallel for both wanted and interfering codeword(s) and such class of IC receivers is referred to as parallel interference cancellation (PIC) receivers. All these exemplary receiver structures are based on the knowledge of detection parameters (e.g. resource allocation, MCS) for both wanted codeword(s) and interfering codeword(s). These receivers are based on various degree of knowledge in terms of detection parameters, for instance post decoding SIC is based on the resource allocation and MCS for the interfering codeword, whereas joint symbol detection is based on the knowledge of the resource allocation and modulation for the interfering codeword.

Another aspect of this invention is directed to signaling of information to support enhanced IC-based receivers.

Downlink control information (DCI) formats over the physical downlink control channel (PDCCH) have been specified, and DCI formats over the enhanced physical downlink control channel (ePDCCH) will also be specified.

According to an embodiment of the invention, the signaling addressed by the above aspects of the invention is embedded in the control information.

In some embodiments of the invention, when a UE is configured in a transmission mode based on UE specific reference symbols such as DM-RS, signaling information for supporting advanced receivers may be based on the current downlink control information formats 2C or 2D. These DCI formats contain a field indicating jointly a used antenna port, a scrambling identity, and a number of layers, i.e. a transmission rank. This field and other fields of the DCI format may be used to indicate information that can be utilized for interference cancellation.

In some embodiments of the invention, when the UE is configured in a transmission mode based on CRS (e.g. TM4) signaling information for supporting advanced receivers may be based on a downlink control information format 2. There are fields currently marked as “reserved” for indicating the content of precoding information which can be reused for the purpose of assisting advanced receivers.

In some embodiments of the invention, a downlink control channel (HS-SCCH) according to a HSPA system is used for the purpose of assisting advanced receivers. In the HSPA downlink MIMO system a common reference signal solution similar to the LTE system is used and applied precoding information is signalled at the HS-SCCH. Hence the LTE CRS based methods stated below are applicable for HSPA also. For example in the HSPA system, signaling of modulation scheme and number of transport blocks information with the applied MIMO precoding information at the HS-SCCH can be reused for the purpose of assisting advanced receivers.

According to some embodiments of the invention, an indication is provided to the UE that the UE may utilize an advanced receiver, for instance a widely linear MMSE-IRC or any kind of enhanced IC-based receiver.

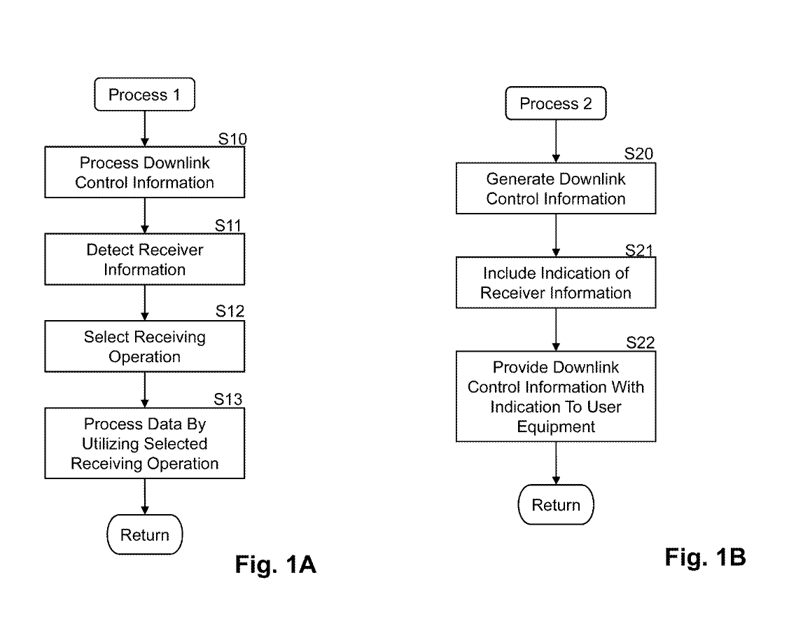

FIG. 1A shows a flowchart illustrating a process 1 of enabling a receiving operation according to an embodiment of the invention. The process 1 may be executed by a user equipment (UE) or part of the UE (e.g. modem).

In step S10, downlink control information are processed, that provide the user equipment with information for reception and decoding of data transmitted from a network node, e.g. a base station, Node B, or eNB, to the user equipment in a mobile communication network which may be part of an LTE communication system. The downlink control information may comply with the formats 2C and/or 2.

In step S11, from the downlink control information, receiver information applicable for interference suppression and/or cancellation are detected. For example, an indication is detected that the UE may utilize an advanced receiver. The receiver information may include a first codeword, a second codeword and an indication that the second codeword is to be interpreted as an interfering codeword for detecting an interfering signal.

In step S12, a receiving operation capable of performing interference suppression and/or cancellation using the receiver information is selected. For instance, a widely linear MMSE-IRC or any kind of enhanced IC-based receiver is selected.

In step S13, the data transmitted from the network node is processed by utilizing the selected receiving operation.

FIG. 1B shows a flowchart illustrating a process 2 of enabling a receiving operation according to an embodiment of the invention. The process 2 may be executed by a network node, e.g. a base station, Node B, or eNB, of a mobile communication network or part of the network node, which may be part of an LTE communication system.

In step S20, downlink control information is generated, that provides a user equipment with information for reception and decoding of data transmitted from the network node to the user equipment in the mobile communication network.

In step S21, into a field of the downlink control information, an indication of receiver information applicable for interference suppression and/or cancellation by a receiving operation of the user equipment is included, the receiving operation being capable of performing interference suppression and/or cancellation using the receiver information. For example, an indication is included that the UE may utilize an advanced receiver. The receiving operation may include a widely linear MMSE-IRC or any kind of enhanced IC-based receiver, e.g. an SIC receiver.

In step S22, the downlink control information including the indication is provided to the user equipment.

In DM-RS based transmission modes, the indication may be provided implicitly by a field in downlink control information which contains information on antenna port, scrambling identity and number of layers.

In CRS based transmission modes, the above indication may be provided implicitly by a field in downlink control information which contains precoding information.

In the case of enhanced IC receivers, this means that there is an interfering signal with the same resource allocation. For example, the interfering signal is indicated by a second codeword in the downlink control information. According to a first option, a modulation and coding scheme (MCS) field in the downlink control information, indicated for the second codeword is used in decoding the interfering signal if transmission is limited to 1 codeword transmission. Alternatively, according to a second option, dual codeword multi-layer transmission can be supported with limited interference signaling capability by additional transport block information signaling for the interfering signal.

In the case of widely linear MMSE-IRC, the indication provided to the UE that the UE may utilize an advanced receiver means that the MCS field is to be interpreted according to real-valued modulations instead of complex-valued modulations.

In the following, some implementation examples of the invention will be described separately for DM-RS based transmission modes and CRS based transmission modes.

### DM-RS Based Transmission Modes:

In the following, the fields and parameters of DCI format 2C are listed (it is noted that DCI format 2D contains the same fields, and an additional field for PDSCH rate matching and quasi-colocation signalling).

Carrier indicator—0 or 3 bits. The field is present when a UE is configured for cross-carrier scheduling.

Resource allocation header (resource allocation type 0/type 1)—1 bit

Resource block assignment

Transmit power control command for PUCCH—2 bits

Downlink Assignment Index (this field is present in TDD for all the uplink-downlink configurations and only applies to TDD operation with uplink-downlink configuration 1-6. This field is not present in FDD)—2 bits

HARQ process number—3 bits (FDD), 4 bits (TDD)

Antenna port(s), scrambling identity and number of layers—3 bits

SRS request—0 or 1 bits. This field can only be present for TDD.

In addition, for transport block 1:

Modulation and coding scheme—5 bits

New data indicator—1 bit

Redundancy version—2 bits

In addition, for transport block 2:

Modulation and coding scheme—5 bits

New data indicator—1 bit

Redundancy version—2 bits

A codeword being enabled or disabled is specified as follows:

In DCI formats 2, 2A, 2B, 2C and 2D a transport block is disabled if I_{MCS}=0 and if rv_{idx}=1; otherwise the transport block is enabled.

Furthermore a transport block to codeword mapping in current 3GPP LTE specification is performed as shown in Table 1 below if one transport block is disabled.

TABLE 1
Transport block to codeword mapping (one transport block enabled)

| transport | transport | codeword 0 | codeword 1 |
|---|---|---|---|
| block 1 | block 2 | (enabled) | (disabled) |
| enabled | Disabled | transport block 1 | — |
| disabled | Enabled | transport block 2 | — |

The following Table 2 illustrates the content of the field used for signaling of antenna port(s), scrambling identity and number of layers according to DCI formats 2C and 2D.

TABLE 2
Antenna port(s), scrambling identity and number
of layers indication on DCI format 2 C/D

| One Codeword: | | Two Codewords: | |
|---|---|---|---|
| Codeword 0 enabled, | | Codeword 0 enabled, | |
| Codeword 1 disabled | | Codeword 1 enabled | |
| Value | Message | Value | Message |
| 0 | 1 layer, port 7, n_{SCID} = 0 | 0 | 2 layers, ports 7-8, n_{SCID} = 0 |
| 1 | 1 layer, port 7, n_{SCID} = 1 | 1 | 2 layers, ports 7-8, n_{SCID} = 1 |
| 2 | 1 layer, port 8, n_{SCID} = 0 | 2 | 3 layers, ports 7-9 |
| 3 | 1 layer, port 8, n_{SCID} = 1 | 3 | 4 layers, ports 7-10 |
| 4 | 2 layers, ports 7-8 | 4 | 5 layers, ports 7-11 |
| 5 | 3 layers, ports 7-9 | 5 | 6 layers, ports 7-12 |
| 6 | 4 layers, ports 7-10 | 6 | 7 layers, ports 7-13 |
| 7 | Reserved | 7 | 8 layers, ports 7-14 |

In an embodiment of the invention, the signaling field of Table 2 is utilized for indications that advanced receivers may utilize. Essentially, the states corresponding to 2 codewords and 5-8 layers are re-defined as shown in Table 3 in which the modifications are indicated in bold. The 3 or 4 layer case with 1 codeword could also be redefined since it is used for retransmissions only. It is noted that the states corresponding to 5-8 layers are applicable for UEs with at least 8 receiving antennas. Such UEs have very good interference suppression capabilities already due to the high number of Rx antennas, hence additional interference rejection capabilities may not be needed. On the other hand it is also noted that 5-8 layers may require very high SINR conditions, in which case interference suppression is also not really needed.

TABLE 3
Modified field for signaling of antenna port(s),
scrambling identity and number of layers

| One Codeword: | | Two Codewords: | |
|---|---|---|---|
| Codeword 0 enabled, | | Codeword 0 enabled, | |
| Codeword 1 disabled | | Codeword 1 enabled | |
| Value | Message | Value | Message |
| 0 | 1 layer, port 7, n_{SCID} = 0 | 0 | 2 layers, ports 7-8, n_{SCID} = 0 |
| 1 | 1 layer, port 7, n_{SCID} = 1 | 1 | 2 layers, ports 7-8, n_{SCID} = 1 |
| 2 | 1 layer, port 8, n_{SCID} = 0 | 2 | 3 layers, ports 7-9 |
| 3 | 1 layer, port 8, n_{SCID} = 1 | 3 | 4 layers, ports 7-10 |
| 4 | 2 layers, ports 7-8 | 4 | 1 layer, port 7, n_{SCID} = 0 |
| 5 | Reserved | 5 | 1 layer, port 7, n_{SCID} = 1 |
| 6 | Reserved | 6 | 1 layer, port 8, n_{SCID} = 0 |
| 7 | Reserved | 7 | 1 layer, port 8, n_{SCID} = 1 |

When redefining the interpretation of the Table, semi static UE specific higher layer signaling could be used to indicate which Table format is used. This enables better UE adaptation for different environments.

In the case of enhanced IC receivers, when the UE configured in a DM-RS based transmission mode receives the DCI format it operates as follows.

In some embodiments of the invention, if the UE receives an indication about two codewords and 1 layer (one layer is indicated as the number of layers) (as highlighted in Table 3), the UE will interpret the other codeword as the interfering codeword. Thus it is assumed that the resource allocation for a UE's own signal and the interfering transmission is the same. The MCS required for decoding of the interfering signals is obtained from the MCS field corresponding to the second codeword.

The UE may then detect the interfering signal first based on the information obtained from the DCI format, cancel out the interference and proceed to detect its own PDSCH. It is noted that any kind of iterative IC methods could be also utilized. Moreover, the SIC receiver may utilize post-decoding bits, or it may be based only on symbol-level interference cancellation in which case only the modulation information is utilized. It is noted that these are just examples of how an IC receiver could operate and there may be other ways of cancelling or mitigating interference with known modulation and (possibly known) coding: for instance, joint detection of the stream of interest together with the interfering stream could also be considered.

In some embodiments of the invention, antenna port information for detection of the interfering signal may for instance be linked to a UE's own antenna port as shown in Table 4 in which modifications with respect to Table 2 are shown in bold. This may be particularly useful in single cell MU-MIMO cases. Furthermore, advanced receivers may benefit from increased DMRS orthogonality. In this case, additional orthogonal antenna ports may be utilized with an increased despreading length (using orthogonal cover code of length 4). The antenna port linkage could then for instance be as shown in Table 5 in which modifications with respect to Table 2 are shown in bold. It should be noted that these are just examples of how to signal the DMRS port for the interfering signal; even adding new explicit bits could be possible.

In some embodiments of the invention, the eNB sets one of these states according to value 4-7 in Tables 3-5 when the eNB can make sure that an interfering signal can be detected by the UE. In that case, the eNB sets the MCS field of the second codeword according to the interfering signal MCS.

TABLE 4
Modified field for signaling of antenna port(s),
scrambling identity and number of layers,
including also the linkage between a UE's own
antenna port and the interfering signal antenna port

| One Codeword: | | Two Codewords: | |
|---|---|---|---|
| Codeword 0 enabled, | | Codeword 0 enabled, | |
| Codeword 1 disabled | | Codeword 1 enabled | |
| Value | Message | Value | Message |
| 0 | 1 layer, port 7, n_{SCID} = 0 | 0 | 2 layers, ports 7-8, n_{SCID} = 0 |
| 1 | 1 layer, port 7, n_{SCID} = 1 | 1 | 2 layers, ports 7-8, n_{SCID} = 1 |
| 2 | 1 layer, port 8, n_{SCID} = 0 | 2 | 3 layers, ports 7-9 |
| 3 | 1 layer, port 8, n_{SCID} = 1 | 3 | 4 layers, ports 7-10 |
| 4 | 2 layers, ports 7-8 | 4 | 1 layer, port 7, n_{SCID} = 0, |
| | | | interference port 8, n_{SCID} = 0 |
| 5 | Reserved | 5 | 1 layer, port 7, n_{SCID} = 1, |
| | | | interference port 8, n_{SCID} = 1 |
| 6 | Reserved | 6 | 1 layer, port 8, n_{SCID} = 0, |
| | | | interference port 7, n_{SCID} = 0 |
| 7 | Reserved | 7 | 1 layer, port 8, n_{SCID} = 1, |
| | | | interference port 7, n_{SCID} = 1 |

TABLE 5
Modified field for signaling of antenna port(s),
scrambling identity and number of layers,
including also the linkage between a UE's own
antenna port and the interfering signal antenna port
in the case of increased DMRS orthogonality

| One Codeword: | | Two Codewords: | |
|---|---|---|---|
| Codeword 0 enabled, | | Codeword 0 enabled, | |
| Codeword 1 disabled | | Codeword 1 enabled | |
| Value | Message | Value | Message |
| 0 | 1 layer, port 7, n_{SCID} = 0 | 0 | 2 layers, ports 7-8, n_{SCID} = 0 |
| 1 | 1 layer, port 7, n_{SCID} = 1 | 1 | 2 layers, ports 7-8, n_{SCID} = 1 |
| 2 | 1 layer, port 8, n_{SCID} = 0 | 2 | 3 layers, ports 7-9 |
| 3 | 1 layer, port 8, n_{SCID} = 1 | 3 | 4 layers, ports 7-10 |
| 4 | 2 layers, ports 7-8 | 4 | 1 layer, port 7, n_{SCID} = 0, |
| | | | interference port 8, n_{SCID} = 0 |
| 5 | Reserved | 5 | 1 layer, port 11, n_{SCID} = 0, |
| | | | interference port 13, n_{SCID} = 0 |
| 6 | Reserved | 6 | 1 layer, port 8, n_{SCID} = 0, |
| | | | interference port 7, n_{SCID} = 0 |
| 7 | Reserved | 7 | 1 layer, port 13, n_{SCID} = 0, |
| | | | interference port 11, n_{SCID} = 0 |

In some embodiments of the invention, allowing additional information to be signalled for the transport block only in the interfering cell for the enhanced IC receiver enables limited support for the dual codeword support for the enhanced IC receiver in the serving cell. This means additional 8 bits of control signalling:

Carrier indicator—0 or 3 bits. The field is present when the UE is configured for cross-carrier scheduling.

Resource allocation header (resource allocation type 0/type 1)—1 bit

Resource block assignment:

Transmit power control command for PUCCH—2 bits

Downlink Assignment Index (this field is present in TDD for all the uplink-downlink configurations and only applies to TDD operation with uplink-downlink configuration 1-6. This field is not present in FDD)-2 bits

HARQ process number—3 bits (FDD), 4 bits (TDD)

Antenna port(s), scrambling identity and number of layers—3 bits as shown in Tables 2 to 5.

SRS request—0 or 1 bits. This field can only be present for TDD.

In addition, for transport block 1:

Modulation and coding scheme—5 bits

New data indicator—1 bit

Redundancy version—2 bits

In addition, for transport block 2:

Modulation and coding scheme—5 bits

New data indicator—1 bit

Redundancy version—2 bits

In addition, for transport block 1 in interfering cell:

Modulation and coding scheme—5 bits

New data indicator—1 bit

Redundancy version—2 bits

Thus, for the transport block 1 in the interfering cell, 8 additional bits of control signaling are added. Signaling the interfering codeword as disabled would mean that no information on the interference is available. Different Tables can be created by modifying the interfering cell port or n_{SCID}. These may even be semi-statically signalled by higher layers.

In the case of widely-linear LMMSE-IRC receivers, when the UE configured in a DM-RS based transmission mode receives the DCI, the UE operates as follows.

In some embodiments of the invention, if the UE receives an indication about real-valued modulations (RVM) as shown in Table 6 (in which modifications with respect to Table 2 are shown in bold), the UE will interpret the MCS field according to real-valued (one-dimensional) modulations instead of current complex-valued M-QAM modulations (CVM).

In some embodiments of the invention, the UE will also assume real-valued demodulation reference signals instead of complex-valued reference signals if use of real valued modulation is signalled.

Similarly to Table 5, increased DMRS orthogonality may be utilized in the context of real-valued modulations.

In some embodiments of the invention, the eNB sets one of the states shown in Table 6 when the UE is scheduled with real-valued modulations. In this case, the eNB also utilizes real-valued reference signals for the DMRS when transmitting to the UE.

In some embodiments of the invention, table 6 may be modified to include entries for a two codeword case for the RVM (e.g. 2 layers, ports 7-8, RVM). In the two codeword case, it may be considered whether both codewords are assumed to be modulated by the RVM modulation or alternatively only one of them which needs to be fixed.

TABLE 6
Modified field for signaling of antenna port(s),
scrambling identity and number of layers,
including also the information about modulation
type (CVM = complex-valued modulation,
RVM = real-valued modulation)

| One Codeword: | | Two Codewords: | |
|---|---|---|---|
| Codeword 0 enabled, | | Codeword 0 enabled, | |
| Codeword 1 disabled | | Codeword 1 enabled | |
| Value | Message | Value | Message |
| 0 | 1 layer, port 7, n_{SCID} = 0, | 0 | 2 layers, ports 7-8, n_{SCID} = 0, |
| | CVM | | CVM |
| 1 | 1 layer, port 7, n_{SCID} = 1, | 1 | 2 layers, ports 7-8, n_{SCID} = 1, |
| | CVM | | CVM |
| 2 | 1 layer, port 8, n_{SCID} = 0, | 2 | 3 layers, ports 7-9, |
| | CVM | | CVM |
| 3 | 1 layer, port 8, n_{SCID} = 1, | 3 | 4 layers, ports 7-10, |
| | CVM | | CVM |
| 4 | 2 layers, ports 7-8, | 4 | 1 layer, port 7, n_{SCID} = 0, |
| | CVM | | RVM |
| 5 | Reserved | 5 | 1 layer, port 7, n_{SCID} = 1, |
| | | | RVM |
| 6 | Reserved | 6 | 1 layer, ports 8, n_{SCID} = 0, |
| | | | RVM |
| 7 | Reserved | 7 | 1 layer, ports 8, n_{SCID} = 1, |
| | | | RVM |

### CRS Based Transmission Modes:

In the following, the fields and parameters of DCI format 2 are listed.

Carrier indicator—0 or 3 bits.

Resource allocation header (resource allocation type 0/type 1)—1 bit

Resource block assignment

TPC command for PUCCH—2 bits

Downlink Assignment Index (this field is present in TDD for all the uplink-downlink configurations and only applies to TDD operation with uplink-downlink configuration 1-6. This field is not present in FDD)—2 bits

HARQ process number—3 bits (FDD), 4 bits (TDD)

Transport block to codeword swap flag—1 bit

In addition, for transport block 1:
Modulation and coding scheme—5 bits
New data indicator—1 bit
Redundancy version—2 bits
   In addition, for transport block 2:
Modulation and coding scheme—5 bits
New data indicator—1 bit
Redundancy version—2 bits
Precoding information—number of bits as specified in Tables 7 and 8.

The following Tables 7 and 8 illustrate the content of the field used for signaling of precoding information.

TABLE 7
Content of precoding information field for 2 antenna ports

| One codeword: | | Two codewords: | |
|---|---|---|---|
| Codeword 0 enabled, | | Codeword 0 enabled, | |
| Codeword 1 disabled | | Codeword 1 enabled | |
| Bit field | | Bit field | |
| mapped | | mapped | |
| to index | Message | to index | Message |
| 0 | 2 layers: Transmit diversity | 0 | 2 layers: Precoding corresponding to precoder matrix $\frac{1}{2} [ \begin{matrix}1 & 1 \\ 1 & - 1\end{matrix} ]$ |
| 1 | 1 layer: Precoding corresponding to precoding vector [1 1]^{T} / \sqrt{2} | 1 | 2 layers: Precoding corresponding to precoder matrix $\frac{1}{2} [ \begin{matrix}1 & 1 \\ j & - j\end{matrix} ]$ |
| 2 | 1 layer: Precoding | 2 | 2 layers: Precoding |
| | corresponding to | | according to the |
| | precoder vector | | latest PMI report on |
| | [1 −1]^{T} / \sqrt{2} | | PUSCH, using the |
| | | | precoder(s) indicated |
| | | | by the reported |
| | | | PMI(s) |
| 3 | 1 layer: Precoding | 3 | reserved |
| | corresponding to | | |
| | precoder vector | | |
| | [1 j]^{T} / 2 | | |
| 4 | 1 layer: Precoding | 4 | reserved |
| | corresponding to | | |
| | precoder vector | | |
| | [1 −j]^{T} / \sqrt{2} | | |
| 5 | 1 1ayer: Precoding | 5 | reserved |
| | according to the latest | | |
| | PMI report on PUSCH, | | |
| | using the precoder(s) | | |
| | indicated by the reported | | |
| | PMI(s), if RI = 2 was | | |
| | reported, using 1^{st} column | | |
| | multiplied by \sqrt{2} of all | | |
| | precoders implied by the | | |
| | reported PMI(s) | | |
| 6 | 1 layer: Precoding | 6 | reserved |
| | according to the latest | | |
| | PMI report on PUSCH, | | |
| | using the precoder(s) | | |
| | indicated by the reported | | |
| | PMI(s), if RI = 2 was | | |
| | reported, using 2^{nd} column | | |
| | multiplied by \sqrt{2} of all | | |
| | precoders implied by the | | |
| | reported PMI(s) | | |
| 7 | Reserved | 7 | reserved |

TABLE 8
Content of precoding information field for 4 antenna ports

| One Codeword: | | Two Codewords: | |
|---|---|---|---|
| Codeword 0 enabled, | | Codeword 0 enabled, | |
| Codeword 1 disabled | | Codeword 1 enabled | |
| Bit field | | Bit field | |
| mapped to | | mapped to | |
| index | Message | index | Message |
| 0 | 4 layers: Transmit | 0 | 2 layers: TPMI = 0 |
| | diversity | | |
| 1 | 1 layer: TPMI = 0 | 1 | 2 layers: TPMI = 1 |
| 2 | 1 layer: TPMI = 1 | . | . |
| | | . | . |
| | | . | . |
| . | . | 15 | 2 layers: TPMI = 15 |
| . | . | | |
| . | . | | |
| 16 | 1 layer: TPMI = 15 | 16 | 2 layers: Precoding |
| | | | according to the latest |
| | | | PMI report on PUSCH |
| | | | using the precoder(s) |
| | | | indicated by the |
| | | | reported PMI(s) |
| 17 | 1 layer: Precoding | 17 | 3 layers: TPMI = 0 |
| | according to the latest | | |
| | PMI report on | | |
| | PUSCH using the | | |
| | precoder(s)indicated | | |
| | by the reported PMI(s) | | |
| 18 | 2 layers: TPMI = 0 | 18 | 3 layers: TPMI = 1 |
| 19 | 2 layers: TPMI = 1 | . | . |
| | | . | . |
| | | . | . |
| . | . | 32 | 3 layers: TPMI = 15 |
| . | . | | |
| . | . | | |
| 33 | 2 layers: TPMI = 15 | 33 | 3 layers: Precoding |
| | | | according to the latest |
| | | | PMI report on PUSCH |
| | | | using the precoder(s) |
| | | | indicated by the |
| | | | reported PMI(s) |
| 34 | 2 layers: Precoding | 34 | 4 layers: TPMI = 0 |
| | according to the latest | | |
| | PMI report on | | |
| | PUSCH using the | | |
| | precoder(s) indicated | | |
| | by the reported PMI(s) | | |
| 35-63 | Reserved | 35 | 4 layers: TPMI = 1 |
| | | . | . |
| | | . | . |
| | | . | . |
| | | 49 | 4 layers: TPMI = 15 |
| | | 50 | 4 layers: Precoding |
| | | | according to the latest |
| | | | PMI report on PUSCH |
| | | | using the precoder(s) |
| | | | indicated by the |
| | | | reported PMI(s) |
| | | 51-63 | Reserved |

In an embodiment of the invention, the signaling of the precoding information is re-used for the indication of the interfering (wideband) PMI in addition to the own PMI for enhanced IC-based receivers in the case of CRS based transmission modes. The states corresponding to 2 codewords enabled and marked as “reserved” may be reused in both Tables 7 and 8. Additionally, if more signaling states are needed, one may:

Redefine fields for 3-4 layers. It is noted that the states corresponding to 3-4 layers are applicable only for UEs with 4 receiving antennas. Such UEs may have good interference suppression capabilities already due to the high number of Rx antennas, hence additional interference rejection capabilities may not be needed. On the other hand, it is also noted that 3-4 layers may require a very high SINR in which case interference suppression may not be needed.

Reuse fields 35-63 marked as “reserved” when one codeword is enabled and the other is disabled and reinterpret the content (for the enhanced IC assistance information which any enhanced IC receiver would take advantage of, an SIC receiver being one such possible receiver, it would then mean that the second codeword is not disabled in fact but corresponds to an interfering codeword).

Add explicit bits for the case of two codewords enabled.

Tables 9 and 10 show an exemplary way of signaling both own (wideband) PMI in addition to the interfering PMI for SIC-based IC as an example of enhanced IC. Modifications with respect to Tables 7 and 8 are shown in bold. In this example, the own signal and corresponding PMI rank-1 (i.e. single stream) as well as the interfering signal and corresponding PMI. Extension to higher ranks for the own and/or interfering signal is possible too.

Signaling of own and interfering wideband PMIs requires in principle a total of N×N states for a precoding codebook with N entries. In LTE, the codebook for rank-1 includes N=4 entries for 2-Tx while there are N=16 entries for 4-Tx. Thus, a total of 16 signaling states would be needed for 2-Tx and 256 signaling states for 4-Tx in order to signal all combinations of own and interfering PMIs. Codebook down-sampling can be used in order to reduce the number of possible combinations. Down-sampling means here selecting only a subset of the precoders from the original codebook. The down-sampled codebook is known to both UE and eNodeB. There are several possible down-sampling strategies, such as joint down-sampling of combinations of both own and interfering PMIs, and full codebook used for the own PMI and down-sampled codebook for the interfering PMI.

Wideband PMI indication has been considered so far for both own and interfering PMI. While full frequency selective signaling of the interfering PMI is not feasible, keeping the frequency selective PMI confirmation bit for the own signal and wideband PMI indication for the interfering signal may be considered instead.

In case of enhanced IC receivers, the UE operation when receiving the DCI format is as follows.

If the UE receives an indication about two codewords and 1 layer (as highlighted in Tables 9 and 10), the UE will interpret the other codeword as the interfering codeword. Thus it is assumed that the resource allocation for a UE's own signal and the interfering transmission is the same. The PMI information for both the wanted and interfering signal is provided by the signaling as depicted in bold in the tables. The MCS required for decoding of the interfering signals is obtained from the MCS field corresponding to the second codeword.

The UE may then detect the interfering signal first based on the information obtained from the DCI format, cancel out the interference and proceed to detect its own PDSCH. Note that the latter is only one exemplary way of how interference cancellation may be performed.

The eNB sets one of these states according to index 3-7 in Table 9 or index 17-63 in Table 10, when the eNB can make sure that an interfering signal can be detected by the UE. In that case, the eNB sets the MCS field of the second codeword according to the interfering signal MCS.

TABLE 9
Modified field for signaling of own and interfering PMI for SIC-based IC
for 2 antenna ports, as an example of enhanced IC

| One codeword: | | Two codewords: | |
|---|---|---|---|
| Codeword 0 enabled, | | Codeword 0 enabled, | |
| Codeword 1 disabled | | Codeword 1 enabled | |
| Bit field | | Bit field | |
| mapped | | mapped | |
| to index | Message | to index | Message |
| 0 | 2 layers: Transmit diversity | 0 | 2 layers: Precoding corresponding to precoder matrix $\frac{1}{2} [ \begin{matrix}1 & 1 \\ 1 & - 1\end{matrix} ]$ |
| 1 | 1 layer: Precoding corresponding to precoding vector [1 1]^{T} / \sqrt{2} | 1 | 2 layers: Precoding corresponding to precoder matrix $\frac{1}{2} [ \begin{matrix}1 & 1 \\ j & - j\end{matrix} ]$ |
| 2 | 1 layer: Precoding | 2 | 2 layers: Precoding |
| | corresponding to | | according to the |
| | precoder vector | | latest PMI report on |
| | [1 −1]^{T} / \sqrt{2} | | PUSCH, using the |
| | | | precoder(s) |
| | | | indicated by the |
| | | | reported PMI(s) |
| 3 | 1 layer: Precoding | 3 | 1 layer: precoder x1 |
| | corresponding to precoder | | 1 interfering layer: |
| | vector [1 j]^{T} / \sqrt{2} | | precoder y1 |
| 4 | 1 layer: Precoding | 4 | 1 layer: precoder x2 |
| | corresponding to precoder | | 1 interfering layer: |
| | vector [1 −j]^{T} / \sqrt{2} | | precoder y2 |
| 5 | 1 layer: Precoding | 5 | 1 layer: precoder x3 |
| | according to the latest | | 1 interfering layer: |
| | PMI report on PUSCH, | | precoder y3 |
| | using the precoder(s) | | |
| | indicated by the reported | | |
| | PMI(s), if RI = 2 was | | |
| | reported, using 1^{st} column | | |
| | multiplied by \sqrt{2} of all | | |
| | precoders implied by the | | |
| | reported PMI(s) | | |
| 6 | 1 layer: Precoding | 6 | 1 layer: precoder x4 |
| | according to the latest | | 1 interfering layer: |
| | PMI report on PUSCH, | | precoder y4 |
| | using the precoder(s) | | |
| | indicated by the reported | | |
| | PMI(s), if RI = 2 was | | |
| | reported, using 2^{nd} column | | |
| | multiplied by \sqrt{2} of all | | |
| | precoders implied by the | | |
| | reported PMI(s) | | |
| 7 | | 7 | 1 layer: precoder x5 |
| | | | 1 interfering layer: |
| | | | precoder y5 |

TABLE 10
Modified field for signaling of own and interfering PMI
for SIC-based IC for 4 antenna ports, as an example of enhanced IC

| One Codeword: | | Two Codewords: | |
|---|---|---|---|
| Codeword 0 enabled, | | Codeword 0 enabled, | |
| Codeword 1 disabled | | Codeword 1 enabled | |
| Bit field | | Bit field | |
| mapped to | | mapped to | |
| index | Message | index | Message |
| 0 | 4 layers: Transmit | 0 | 2 layers: TPMI = 0 |
| | diversity | | |
| 1 | 1 layer: TPMI = 0 | 1 | 2 layers: TPMI = 1 |
| 2 | 1 layer: TPMI = 1 | . | . |
| | | . | . |
| | | . | . |
| . | . | 15 | 2 layers: TPMI = 15 |
| . | . | | |
| . | . | | |
| 16 | 1 layer: TPMI = 15 | 16 | 2 layers: Precoding |
| | | | according to the latest |
| | | | PMI report on PUSCH |
| | | | using the precoder(s) |
| | | | indicated by the |
| | | | reported PMI(s) |
| 17 | 1 layer: Precoding | 17 | 1 layer: precoder × 1 |
| | according to the | | 1 interfering layer: |
| | latest PMI report on | | precoder y1 |
| | PUSCH using the | | |
| | precoder(s) indicated by | | |
| | the reported PMI(s) | | |
| 18 | 2 layers: TPMI = 0 | 18 | 1 layer: precoder × 2 |
| | | | 1 interfering layer: |
| | | | precoder y2 |
| 19 | 2 layers: TPMI = 1 | . | . |
| | | . | . |
| | | . | . |
| . | . | 32 | 1 layer: precoder × 16 |
| . | . | | 1 interfering layer: |
| . | . | | precoder y16 |
| 33 | 2 layers: TPMI = 15 | 33 | 1 layer: precoder × 17 |
| | | | 1 interfering layer: |
| | | | precoder y17 |
| 34 | 2 layers: Precoding | 34 | 1 layer: precoder × 18 |
| | according to the | | 1 interfering layer: |
| | latest PMI report on | | precoder y18 |
| | PUSCH using the | | |
| | precoder(s) indicated by | | |
| | the reported PMI(s) | | |
| 35-63 | Reserved | 35 | 1 layer: precoder × 19 |
| | | | 1 interfering layer: |
| | | | precoder y19 |
| | | . | . |
| | | . | . |
| | | . | . |
| | | 49 | 1 layer: precoder × 33 |
| | | | 1 interfering layer: |
| | | | precoder y33 |
| | | 50 | 1 layer: precoder × 34 |
| | | | 1 interfering layer: |
| | | | precoder y34 |
| | | 51 | 1 layer: precoder × 35 |
| | | | 1 interfering layer: |
| | | | precoder y35 |
| | | . | |
| | | . | |
| | | . | |
| | | 63 | 1 layer: precoder × 47 |
| | | | 1 interfering layer: |
| | | | precoder y47 |

In another embodiment of the invention, the signaling of the precoding information is re-used for the indication that real-valued modulations (RVM) are used instead of complex valued modulations (CVM) in the case of widely-linear LMMSE-IRC receivers. An exemplary signaling is provided for 2 and 4 antenna ports at eNodeB in Tables 11 and 12, respectively where proposed modifications are shown in bold. In the example of Table 11 the support for the precoder selection of the 2 codeword RVM transmission is limited. Table 12 supports 4 layer precoded CVM transmission with limited precoder set. Furthermore, only 1 and 2 layer RVM transmission is supported but with full range of precoder selection matrices. It is to be noted that precoder subset restriction may be utilized as described above. Additionally, RVM based 2 layer transmit diversity may be allowed as done e.g. in the example in Table 11.

In case of widely-linear LMMSE-IRC receivers, the UE operation when receiving the DCI format is as follows.

If the UE receives an indication about real-valued modulations (RVM) as shown in Tables 11 and 12, the UE will interpret the MCS field according to real-valued modulations instead of current complex-valued M-QAM modulations (CVM).

The eNB sets one of the states according to index 7 for one codeword or index 3-7 for two codewords for two antenna ports (Table 11), or index 35-51 for one codeword or index 47-63 for two codewords for 4 antenna ports (Table 12), when the UE is scheduled with real-valued modulations. In this case, the eNB also utilizes real-valued reference signals for the DMRS when transmitting to the UE.

TABLE 11
Content of precoding information field for 2 antenna ports

| One codeword: | | Two codewords: | |
|---|---|---|---|
| Codeword 0 enabled, | | Codeword 0 enabled, | |
| Codeword 1 disabled | | Codeword 1 enabled | |
| Bit field | | Bit field | |
| mapped | | mapped | |
| to index | Message | to index | Message |
| 0 | CVM: 2 layers: Transmit diversity | 0 | CVM: 2 layers: Precoding corresponding to precoder matrix $\frac{1}{2} [ \begin{matrix}1 & 1 \\ 1 & - 1\end{matrix} ]$ |
| 1 | CVM: 1 layer: Precoding corresponding to precoding vector [1 1]^{T} / \sqrt{2} | 1 | CVM: 2 layers: Precoding corresponding to precoder matrix $\frac{1}{2} [ \begin{matrix}1 & 1 \\ j & - j\end{matrix} ]$ |
| 2 | CVM: 1 layer: Precoding | 2 | CVM: 2 layers: |
| | corresponding to | | Precoding according |
| | precoder vector | | to the latest PMI |
| | [1 −1]^{T} / \sqrt{2} | | report on PUSCH, |
| | | | using the precoder(s) |
| | | | indicated by the |
| | | | reported PMI(s) |
| 3 | CVM: 1 layer: Precoding | 3 | RVM: 2 layers: |
| | corresponding to | | Transmit diversity |
| | precoder vector | | |
| | [1 j]^{T} / \sqrt{2} | | |
| 4 | CVM: 1 layer: Precoding corresponding to precoder vector [1 −j]^{T} / \sqrt{2} | 4 | RVM: 2 layers: Precoding corresponding to precoding vector $\frac{1}{2} [ \begin{matrix}1 & 1 \\ 1 & - 1\end{matrix} ]$ |
| 5 | CVM: 1 layer: Precoding | 5 | RVM: 1 layer: |
| | according to the latest | | Precoding |
| | PMI report on PUSCH, | | corresponding to |
| | using the precoder(s) | | precoding vector |
| | indicated by the reported | | [1 −1]^{T} / \sqrt{2} |
| | PMI(s), if RI = 2 was | | |
| | reported, using 1^{st} column | | |
| | multiplied by \sqrt{2} of all | | |
| | precoders implied by the | | |
| | reported PMI(s) | | |
| 6 | CVM: 1 layer: Precoding | 6 | RVM: 1 layer: |
| | according to the latest | | Precoding |
| | PMI report on PUSCH, | | corresponding to |
| | using the precoder(s) | | precoder vector |
| | indicated by the reported | | [1 j]^{T} / \sqrt{2} |
| | PMI(s), if RI = 2 was | | |
| | reported, using 2^{nd} | | |
| | column multiplied by \sqrt{2} | | |
| | of all precoders implied | | |
| | by the reported PMI(s) | | |
| 7 | RVM: 1 layer: Precoding | 7 | RVM: 1 layer: |
| | corresponding to | | Precoding |
| | precoding vector | | corresponding to |
| | [1 1]^{T} / \sqrt{2} | | precoder vector |
| | | | [1 −j]^{T} / \sqrt{2} |

TABEL 12
Content of precoding information field for 4 antenna ports

| One Codeword: | | Two Codewords: | |
|---|---|---|---|
| Codeword 0 enabled, | | Codeword 0 enabled, | |
| Codeword 1 disabled | | Codeword 1 enabled | |
| Bit field | | Bit field | |
| mapped to | | mapped to | |
| index | Message | index | Message |
| 0 | CVM: 4 layers: Transmit diversity | 0 | CVM: 2 layers: TPMI = 0 |
| 1 | CVM: 1 layer: TPMI = 0 | 1 | CVM: 2 layers: TPMI = 1 |
| 2 | CVM: 1 layer: TPMI = 1 | . | . |
| | | . | . |
| | | . | . |
| . | . | 15 | CVM: 2 layers: TPMI = 15 |
| . | . | | |
| . | . | | |
| 16 | CVM: 1 layer: TPMI = 15 | 16 | CVM: 2 layers: Precoding according |
| | | | to the latest PMI report on |
| | | | PUSCH using the precoder(s) |
| | | | indicated by the reported |
| | | | PMI(s) |
| 17 | CVM: 1 layer: Precoding | 17 | CVM: 3 layers: TPMI = 0 |
| | according to the latest PMI | | |
| | report on PUSCH using | | |
| | the precoder(s) indicated | | |
| | by the reported PMI(s) | | |
| 18 | CVM: 2 layers: TPMI = 0 | 18 | CVM: 3 layers: TPMI = 1 |
| 19 | CVM: 2 layers: TPMI = 1 | . | . |
| | | . | . |
| | | . | . |
| . | . | 32 | CVM: 3 layers: TPMI = 15 |
| . | . | | |
| . | . | | |
| 33 | CVM: 2 layers: TPMI = 15 | 33 | CVM: 3 layers: Precoding according |
| | | | to the latest PMI report on |
| | | | PUSCH using the precoder(s) |
| | | | indicated by the reported |
| | | | PMI(s) |
| 34 | CVM: 2 layers: Precoding | 34 | CVM: 4 layers: TPMI = 0 |
| | according to the latest PMI | | |
| | report on PUSCH using | | |
| | the precoder(s) indicated | | |
| | by the reported PMI(s) | | |
| 35 | RVM: 1 layer: TPMI = 0 | 35 | CVM: 4 layers: TPMI = 1 |
| . | . | . | . |
| . | . | . | . |
| . | . | . | . |
| 45 | RVM: 1 layer: TPMI = 10 | 45 | CVM: 4 layers: TPMI = 11 |
| 46 | RVM: 1 layer: TPMI = 11 | 46 | CVM: 4 layers: Precoding according |
| | | | to the latest PMI report on |
| | | | PUSCH using the precoder(s) |
| | | | indicated by the reported |
| | | | PMI(s) |
| 47 | RVM: 1 layer: TPMI = 12 | 47 | RVM: 2 layers: TPMI = 0 |
| 48 | RVM: 1 layer: TPMI = 13 | 48 | RVM: 2 layers: TPMI = 1 |
| 49 | RVM: 1 layer: TPMI = 14 | 49 | RVM: 2 layers: TPMI = 2 |
| 50 | RVM: 1 layer: TPMI = 15 | 50 | RVM: 2 layers: TPMI = 3 |
| 51 | RVM: 1 layer: Precoding | 51 | RVM: 2 layers: TPMI = 4 |
| | according to the latest PMI report | | |
| | on PUSCH using the precoder(s) | | |
| | indicated by the reported PMI(s) | | |
| 52 | Reserved | 52 | RVM: 2 layers: TPMI = 5 |
| 53-61 | . | 53-61 | . |
| | . | | . |
| | . | | . |
| 62 | Reserved | 62 | RVM: 2 layers: TPMI = 15 |
| 63 | Reserved | 63 | RVM: 2 layers: Precoding according to |
| | | | to the latest PMI report on |
| | | | PUSCH using the precoder(s) |
| | | | indicated by the reported |
| | | | PMI(s) |

According to an embodiment of the invention, widely linear LMMSE-IRC receivers can take advantage of real valued modulations, since dynamic signaling of complex- and real-valued modulation is enabled without increasing DCI overhead.

Moreover, regarding enhanced IC receivers, some embodiments of the invention enable cancellation of one dominant interferer and in particular informing the UE about the detection parameters (resource allocation, MCS) of the dominant interferer. According to some embodiment, this is also carried out without increasing DCI overhead.

Some embodiments of the invention may lead to efficient interference cancellation and/or suppression in low SINR conditions. Additionally, some embodiments of the invention may be applied in both CRS and DM-RS based transmission modes.

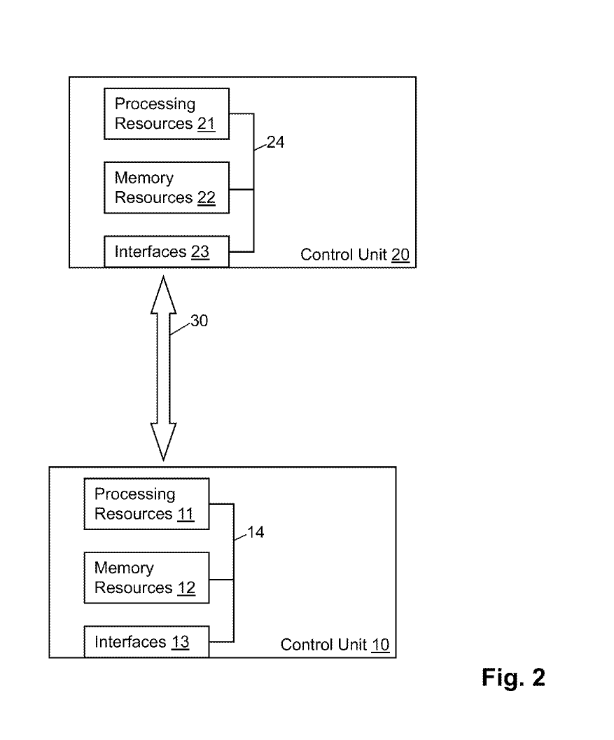

Now reference is made to FIG. 2 for illustrating a simplified block diagram of various electronic devices that are suitable for use in practicing the exemplary embodiments of this invention.

A control circuitry or control unit 10, which may be used for executing process 1 shown in FIG. 1A and may be part of or used by a user equipment, includes a processing system and/or processing resources 11, memory resources 12 and interfaces 13 which are connected by a link 14. The memory resources 12 may store a program. The control unit 10 may receive data or may cause transmission of data via the interfaces 13 through a wireless connection 30.

A control circuitry or control unit 20, which may be used for executing process 2 shown in FIG. 1B and may be part of or used by a network node, e.g. a base station, Node B, or eNB, includes a processing system and/or processing resources 21, memory resources 22 and interfaces 23 which are connected by a link 24. The memory resources 22 may store a program. The control unit 20 may receive data or may cause transmission of data via the interfaces 23 through a wireless connection 30 towards the control unit 10.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein, two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

The programs stored in the memory resources 12, 22 are assumed to include program instructions that, when executed by the associated processing resources, enable the electronic device to operate in accordance with the exemplary embodiments of this invention, as detailed above. Inherent in the processing resources is a clock to enable synchronism among the various apparatus for transmissions and receptions within the appropriate time intervals and slots required, as the scheduling grants and the granted resources/subframes are time dependent. The interfaces 13, 23 include transceivers including both transmitter and receiver, and inherent in each is a modulator/demodulator commonly known as a modem.

In general, the exemplary embodiments of this invention may be implemented by computer software stored in the memory resources 12, 22 and executable by the processing resources 11, 21, or by hardware, or by a combination of software and/or firmware and hardware in any or all of the devices shown.

In general, the various embodiments of a UE described above can include, but are not limited to, mobile stations, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The memory resources 12, 22 may be of any type suitable to the local technical environment and may be implemented using any suitable data storage technology, such as semiconductor-based memory devices, magnetic memory devices and systems, optical memory devices and systems, fixed memory and removable memory. The processing resources 11, 21 may be of any type suitable to the local technical environment, and may include one or more of general purpose computers, special purpose computers, microprocessors, digital signal processors (DSPs) and processors based on a multi-core processor architecture, as non-limiting examples.

As used herein, the term ‘circuitry’ refers to all of the following:

(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term ‘circuitry’ would also cover an implementation of merely a processor (or multiple processors) or portion of a processor and its (or their) accompanying software and/or firmware. The term ‘circuitry’ would also cover, for example and if applicable to the particular claim element, a baseband integrated circuit or applications processor integrated circuit for a mobile phone or a similar integrated circuit in server, a cellular network device, or other network device.

According to an aspect of the invention, an apparatus for use in a user equipment is provided. The apparatus may include or use the control unit 10. The apparatus includes means for processing downlink control information that provides the user equipment with information for reception and decoding of data transmitted from a network node to the user equipment in a mobile communication network, means for detecting, from the downlink control information, receiver information applicable for interference suppression/cancellation, and means for selecting a receiving operation capable of performing interference suppression/cancellation using the receiver information, wherein the means for processing process the data transmitted from the network node by utilizing the receiving operation selected by the means for selecting.

The downlink control information may correspond to a transmission mode of the user equipment.

According to an implementation example, the receiver information may include a first codeword, a second codeword and an indication that the second codeword is to be interpreted as an interfering codeword for detecting an interfering signal.

For example, as the receiving operation, the means for selecting select a receiving operation which interprets the second codeword as interfering codeword for detecting the interfering signal. The receiving operation selected may be capable of performing an enhanced interference cancellation, e.g. a successive interference cancellation.

The means for detecting may detect the receiver information from a field of the downlink control information that is used for signaling antenna ports, scrambling identity and a number of layers, the receiver information including the first codeword and the second codeword, an indication of one layer as the number of layers, an indication of at least one antenna port and at least one scrambling identity. Note that an “indication of one layer as the number of layers” should be taken to mean that ‘an indication of one layer’ is put into the field of/corresponds to ‘the number of layers’.

The receiver information may include the indication of an antenna port for detecting the interfering signal.

According to an example, the apparatus may include means for decoding the interfering signal based on a modulation and coding scheme indicated in a field of the downlink control information, corresponding to the second codeword.

According to another example, the downlink control information may include information for a transport block in an interfering cell, and the means for decoding may decode the interfering signal based on a modulation and coding scheme indicated in the information for the transport block.

According to another implementation example, the means for detecting may detect the receiver information from a field of the downlink control information that is used for signaling antenna ports, scrambling identity and a number of layers, the receiver information including an indication of a specific modulation type, and the means for selecting may select a receiving operation as the receiving operation, which interprets a modulation and coding scheme indicated in a field of the downlink control information, corresponding to a first and/or second codeword indicated by the field, according to the specific modulation type.

The means for detecting may detect that the field of the downlink control information includes an indication of the receiver information based on a higher layer signaling between the network node and the user equipment.

According to a further implementation example, the means for detecting may detect the receiver information from a field of the downlink control information that is used for signaling preceding information, the receiver information including the first codeword and the second codeword, one layer with a precoding matrix indication, and one interfering layer with a precoding matrix indication.

According to still another implementation example, the means for detecting may detect the receiver information from a field of the downlink control information that is used for signaling precoding information, the receiver information including a first codeword and/or a second codeword, at least one layer, a precoding matrix indication, and an indication of a specific modulation type, and the means for selecting may select a receiving operation as the receiving operation, which interprets a modulation and coding scheme indicated in a field of the downlink control information, corresponding to the first and/or second codeword according to the specific modulation type.

The specific modulation type may include a real-valued modulation.

The above-mentioned means including the means for processing, detecting, selecting and decoding may be implemented by the processing resources 11, memory resources 12 and interfaces 13 of the control unit 10.

According to another aspect of the invention, an apparatus for use in a network node is provided, which may include or use the control unit 20. The apparatus includes means for generating downlink control information that provides a user equipment with information for reception and decoding of data transmitted from the network node to the user equipment in a mobile communication network, means for including, into a field of the downlink control information, an indication of receiver information applicable for interference suppression/cancellation by a receiving operation of the user equipment, capable of performing interference suppression/cancellation using the receiver information, and means for providing the downlink control information including the indication to the user equipment.

The receiver information may include a first codeword, a second codeword and indication that the second codeword is to be interpreted as an interfering codeword for detecting an interfering signal.

According to an implementation example, the means for including may include the indication of the receiver information into a field of the downlink control information that is used for signaling antenna ports, scrambling identity and a number of layers, the receiver information including the first codeword and the second codeword, an indication of one layer as the number of layers, an indication of at least one antenna port and at least one scrambling identity.

According to an example, the apparatus may further include means for setting a modulation and coding scheme for the second codeword, indicated in a field of the downlink control information, to a modulation and coding scheme of the interfering signal.

According to another example, the means for including may include information for a transport block in an interfering cell into the downlink control information.

According to another implementation example, the means for including may include the indication of the receiver information into a field of the downlink control information that is used for signaling antenna ports, scrambling identity and a number of layers, the receiver information including an indication of a specific modulation type.

The means for providing may provide higher layer signaling to the user equipment, indicating that the field of the downlink control information includes an indication of the receiver information.

According to a further implementation example, the means for including may include the indication of the receiver information into a field of the downlink control information that is used for signaling precoding information, the receiver information including the first codeword and the second codeword, one layer with a precoding matrix indication, and one interfering layer with a precoding matrix indication.

According to still another implementation example, the means for including may include the indication of the receiver information into a field of the downlink control information that is used for signaling precoding information, the receiver information including a first codeword and/or a second codeword, at least one layer, a precoding matrix indication, and an indication of a specific modulation type.

The specific modulation type may include a real-valued modulation.

The above-mentioned means including the means for generating, providing, including and setting may be implemented by the processing resources 21, memory resources 22 and interfaces 23 of the control unit 20.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of enabling a receiving operation, the method comprising:
processing downlink control information that provides a user equipment with information for reception and decoding of data transmitted from a network node to the user equipment in a mobile communication network;
detecting, from the downlink control information, receiver information applicable for interference suppression and/or cancellation;
selecting a receiving operation capable of performing interference suppression and/or cancellation using the receiver information; and
processing the data transmitted from the network node by utilizing the selected receiving operation.

2. The method according to claim 1, wherein at least one of:
the downlink control information corresponds to a transmission mode of the user equipment;
the receiver information comprises a first codeword, a second codeword and an indication that the second codeword is to be interpreted as an interfering codeword for detecting an interfering signal;
as the receiving operation, a receiving operation is selected which interprets the second codeword as an interfering codeword for detecting the interfering signal; and
the selected receiving operation is capable of performing at least one of an enhanced interference cancellation and suppression.

3. The method according to claim 1, wherein at least one of:
the receiver information is detected from a field of the downlink control information that is used for signaling antenna ports, scrambling identity and a number of layers, the receiver information comprising the first codeword and the second codeword, an indication of one layer as the number of layers, an indication of at least one antenna port and at least one scrambling identity, and
the receiver information comprises the indication of an antenna port for detecting the interfering signal.

4. The method according to claim 2, wherein at least one of:
the interfering signal is decoded based on a modulation and coding scheme indicated in a field of the downlink control information, corresponding to the second codeword;
the downlink control information includes information for a transport block in an interfering cell, and the interfering signal is decoded based on a modulation and coding scheme indicated in the information for the transport block;
the method further comprising detecting the field of the downlink control information includes an indication of the receiver information based on a higher layer signaling between the network node and the user equipment; and
the receiver information is detected from a field of the downlink control information that is used for signaling precoding information, the receiver information comprising the first codeword and the second codeword, one layer with a precoding matrix indication, and one interfering layer with a precoding matrix indication.

5. The method according to claim 1, wherein at least one of:
a) the receiver information is detected from a field of the downlink control information that is used for signaling antenna ports, scrambling identity and a number of layers, the receiver information comprising an indication of a specific modulation type, and
a receiving operation is selected as the receiving operation, which interprets a modulation and coding scheme indicated in a field of the downlink control information, corresponding to a first and/or second codeword indicated by the field, according to the specific modulation type; and
b) the receiver information is detected from a field of the downlink control information that is used for signaling precoding information, the receiver information comprising a first codeword and/or a second codeword, at least one layer, a precoding matrix indication, and an indication of a specific modulation type, and
a receiving operation is selected as the receiving operation, which interprets a modulation and coding scheme indicated in a field of the downlink control information, corresponding to the first and/or second codeword according to the specific modulation type.

6. A method of enabling a receiving operation, the method comprising:
generating downlink control information that provides a user equipment with information for reception and decoding of data transmitted from a network node to the user equipment in a mobile communication network;
including, into a field of the downlink control information, an indication of receiver information applicable for interference suppression and/or cancellation by a receiving operation of the user equipment, capable of performing interference suppression and/or cancellation using the receiver information; and
providing the downlink control information including the indication to the user equipment.

7. The method according to claim 6, wherein at least one of:
the receiver information comprises a first codeword, a second codeword and an indication that the second codeword is to be interpreted as an interfering codeword for detecting an interfering signal; and
the indication of the receiver information is included into a field of the downlink control information that is used for signaling antenna ports, scrambling identity and a number of layers, the receiver information comprising the first codeword and the second codeword, an indication of one layer as the number of layers, an indication of at least one antenna port and at least one scrambling identity.

8. The method according to claim 6, wherein at least one of:
the method further comprising including information for a transport block in an interfering cell into the downlink control information;
the indication of the receiver information is included into a field of the downlink control information that is used for signaling antenna ports, scrambling identity and a number of layers, the receiver information comprising an indication of a specific modulation type;
the method further comprising providing higher layer signaling to the user equipment, indicating that the field of the downlink control information includes an indication of the receiver information;
the indication of the receiver information is included into a field of the downlink control information that is used for signaling precoding information, the receiver information comprising the first codeword and the second codeword, one layer with a precoding matrix indication, and one interfering layer with a precoding matrix indication; and
the indication of the receiver information is included into a field of the downlink control information that is used for signaling precoding information, the receiver information comprising a first codeword and/or a second codeword, at least one layer, a precoding matrix indication, and an indication of a specific modulation type.

9. A non-transitory computer-readable storage medium comprising a set of computer-readable instructions stored thereon, which, when executed by a processor, causes the processor performs the steps of claim 1 when the computer-readable instructions are executed by the processor.

10. A non-transitory computer-readable storage medium comprising a set of computer-readable instructions stored thereon, which, when executed by a processor, causes the processor performs the steps of claim 6 when the computer-readable instructions are executed by the processor.

11. An apparatus for enabling a receiving operation in a user equipment, the apparatus comprising a processing system configured to cause the apparatus at least to:
process downlink control information that provides the user equipment with information for reception and decoding of data transmitted from a network node to the user equipment in a mobile communication network;
detect, from the downlink control information, receiver information applicable for interference suppression and/or cancellation;
select a receiving operation capable of performing interference suppression and/or cancellation using the receiver information; and
process the data transmitted from the network node by utilizing the selected receiving operation.

12. The apparatus according to claim 11, wherein at least one of:
the downlink control information corresponds to a transmission mode of the user equipment;
the receiver information comprises a first codeword, a second codeword and an indication that the second codeword is to be interpreted as an interfering codeword for detecting an interfering signal;
the processing system is configured to cause the apparatus at least to select, as the receiving operation, a receiving operation which interprets the second codeword as an interfering codeword for detecting the interfering signal; and
the selected receiving operation is capable of performing an enhanced interference cancellation.

13. The apparatus according to claim 12, wherein at least one of:
the processing system is configured to cause the apparatus at least to detect the receiver information from a field of the downlink control information that is used for signaling antenna ports, scrambling identity and a number of layers, the receiver information comprising the first codeword and the second codeword, an indication of one layer as the number of layers, an indication of at least one antenna port and at least one scrambling identity,
the receiver information comprises the indication of an antenna port for detecting the interfering signal;
the processing system is configured to cause the apparatus at least to decode the interfering signal based on a modulation and coding scheme indicated in a field of the downlink control information, corresponding to the second codeword; and
the downlink control information includes information for a transport block in an interfering cell, and the processing system is configured to cause the apparatus at least to decode the interfering signal based on a modulation and coding scheme indicated in the information for the transport block.

14. The apparatus according to claim 11, wherein the processing system is configured to cause the apparatus to at least one of:
a) detect the receiver information from a field of the downlink control information that is used for signaling antenna ports, scrambling identity and a number of layers, the receiver information comprising an indication of a specific modulation type, and
select a receiving operation as the receiving operation, which interprets a modulation and coding scheme indicated in a field of the downlink control information, corresponding to a first and/or second codeword indicated by the field, according to the specific modulation type;
b) detect that the field of the downlink control information includes an indication of the receiver information based on a higher layer signaling between the network node and the user equipment;
c) detect the receiver information from a field of the downlink control information that is used for signaling precoding information, the receiver information comprising the first codeword and the second codeword, one layer with a precoding matrix indication, and one interfering layer with a precoding matrix indication; and
d) detect the receiver information from a field of the downlink control information that is used for signaling precoding information, the receiver information comprising a first codeword and/or a second codeword, at least one layer, a precoding matrix indication, and an indication of a specific modulation type, and
select a receiving operation as the receiving operation, which interprets a modulation and coding scheme indicated in a field of the downlink control information, corresponding to the first and/or second codeword according to the specific modulation type.

15. The apparatus according to claim 11, wherein at least one of:
the apparatus comprises a user equipment; and
the apparatus is configured for use in a long term evolution system.

16. An apparatus for enabling a receiving operation in a network node, the apparatus comprising a processing system configured to cause the apparatus at least to:
generate downlink control information that provides a user equipment with information for reception and decoding of data transmitted from the network node to the user equipment in a mobile communication network;
include, into a field of the downlink control information, an indication of receiver information applicable for interference suppression and/or cancellation by a receiving operation of the user equipment, capable of performing at least one of interference suppression and cancellation using the receiver information; and
provide the downlink control information including the indication to the user equipment.

17. The apparatus according to claim 16, wherein at least one of:
the receiver information comprises a first codeword, a second codeword and an indication that the second codeword is to be interpreted as an interfering codeword for detecting an interfering signal;
the processing system is configured to cause the apparatus at least to include the indication of the receiver information into a field of the downlink control information that is used for signaling antenna ports, scrambling identity and a number of layers, the receiver information comprising the first codeword and the second codeword, an indication of one layer as the number of layers, an indication of at least one antenna port and at least one scrambling identity.

18. The apparatus according to claim 17, wherein the processing system is configured to cause the apparatus to at least one of:
set a modulation and coding scheme for the second codeword, indicated in a field of the downlink control information, to a modulation and coding scheme of the interfering signal; and
include information for a transport block in an interfering cell into the downlink control information.

19. The apparatus according to claim 16, wherein the processing system is configured to cause the apparatus to at least one of:
include the indication of the receiver information into a field of the downlink control information that is used for signaling antenna ports, scrambling identity and a number of layers, the receiver information comprising an indication of a specific modulation type;
provide higher layer signaling to the user equipment, indicating that the field of the downlink control information includes an indication of the receiver information;
include the indication of the receiver information into a field of the downlink control information that is used for signaling precoding information, the receiver information comprising the first codeword and the second codeword, one layer with a precoding matrix indication, and one interfering layer with a precoding matrix indication; and
include the indication of the receiver information into a field of the downlink control information that is used for signaling precoding information, the receiver information comprising a first codeword and/or a second codeword, at least one layer, a precoding matrix indication, and an indication of a specific modulation type.

20. The apparatus according to claim 16, wherein at least one of:
the apparatus comprises at least one of a base station, a NodeB and an eNodeB; and
the apparatus is configured for use in a long term evolution system.
